(19) United States
(12) Patent Application Publication
(10) Pub. No.: US 2008/0184330 A1
(43) Pub. Date: Jul. 31, 2008

(54) LEVELS OF ACCESS TO MEDICAL DIAGNOSTIC FEATURES BASED ON USER LOGIN

(76) Inventors: Rakesh M. Lal, Waukesha, WI (US); Laurent Launay, Saint Remy Les Chevreuse (FR); Cheryl R Jones, Hubertus, WI (US); Toan T. Le, Germantown, WI (US); David C. Mack, Waukesha, WI (US); Helen H. Peng, Brookfield, WI (US); Xin Wan, Pewaukee, WI (US); Guy G Bernard, Fontenay Aux Roses (FR)

Correspondence Address: RAMIREZ & SMITH, PO BOX 341179, AUSTIN, TX, 78734, US

(21) Appl. No.: 11/627,342

(22) Filed: Jan. 25, 2007

(51) Int. Cl. G06F 21/00

(52) U.S. Cl. 726/1

(57) ABSTRACT

Systems, apparatus, and computer methods are provided for controlling access to advanced medical diagnostic imaging applications based on the login credential of a user and the access policy for that user. All users are categorized based on training, authorization, and status with an identified project. The advanced medical diagnostic imaging applications are configured based on the retrieved access policy for the user.

### FIELD OF THE INVENTION

This invention relates generally to managing advanced medical diagnostic imaging applications executing on a network or a computer, and more specifically enforcing specific access policy provisions on features on advanced medical diagnostic imaging applications.

### BACKGROUND OF THE INVENTION

Currently in the medical imaging field, numerous advanced medical imaging applications (ADIA) are used to provide an array of diagnostic imaging capabilities. Many of these ADIA have a basic set of operating features that place the application in a basic operating configuration in which the operator has certain basic operating controls over the software. In some cases, the application has or can be supplemented with additional operating features that provide enhanced operating capabilities. However not every clinician or operator of an application require or even desire access to all configurations that may be available. In fact, in the case of an application that may have the capability to operate in many different configurations or have many different operating features that can be made available, clinicians frequently differ on the configurations they desire to have and reasons for restricting the number of possible configurations. In many clinical environments, advanced medical imaging diagnostic application tools are precious resources, as they typically require hospitals to purchase expensive licenses to use the applications, and as such, it is important for hospitals to prioritize and possibly reserve access to these applications for the specific users who derive the maximum benefit.

Cost may be a consideration in the choice of operating configurations as software with more available operating configurations typically have higher licensing fees than software having fewer operating configurations. Historically, advanced applications resided on a dedicated workstation where users had to be physically present in order to use the applications. Thus, hospitals could manage access to the applications by controlling access to this workstation. Today however, the world of medical diagnostic applications is changing such that applications are being developed within a client server framework, and applications can be accessed from any location over the hospital's intranet or over the Internet, by logging into a central application server system. As the needs of the multitude of application users vary tremendously in a clinical site, and given the high cost of licenses to use an application, it would be quite inefficient for a site to allow users who did not need a particular application to have access to use that application.

In addition to managing user access to specific applications, there is a need to manage a user's access to specific features in a set of applications. Specifically, many diagnostic applications have sophisticated features that may require special skills and training to use properly, and therefore allowing untrained physicians or radiologists to access these features could result in misdiagnosis. Moreover, some users may be referring physicians who wish to view a radiologist's analysis, and the radiologist may not want to allow the referring physician to make modifications or save or delete items related to the diagnosis. Thus, it may be desirable to manage application features based on a user's role rather than at the application level.

For the reasons stated above, and for other reasons stated below which will become apparent to those skilled in the art upon reading and understanding the present specification, there is a need in the art for managing advanced medical diagnostic imaging applications executing on a network or a computer. There is also a need for improved access policy enforcement of features on advanced medical diagnostic imaging applications.

### BRIEF DESCRIPTION OF THE INVENTION

The above-mentioned shortcomings, disadvantages and problems are addressed herein, which will be understood by reading and studying the following specification.

In one aspect, a computer-accessible medium having executable instructions for directing a processor to perform receiving login credential from a user; retrieving based on the received login credential of the user the access policy to advanced medical diagnostic imaging applications for the user; configuring desired advanced medical diagnostic imaging applications based on the retrieved access policy for the user; and presenting the configured advanced medical diagnostic imaging applications to the user.

In another aspect, the login credential from the user is one or more password, token, data signal, login identification; the access policy is one of no access to the advanced medical diagnostic imaging applications, limited access to the advanced medical diagnostic imaging applications, or unfettered access to the advanced medical diagnostic imaging applications.

In yet another aspect, users are one or more key user, authorized user, trained user, untrained user, unauthorized user, invited user.

In still another aspect, configuring desired advanced medical diagnostic imaging applications is one of denying access to the user, providing access only to some of the features of the desired advanced medical diagnostic imaging applications, denying access to control features of the desired advanced medical diagnostic imaging applications, denying access to some features and to control features of the desired advanced medical diagnostic imaging applications.

In another aspect, a control feature is at least editing feature, saving feature, deleting feature, opening feature.

In yet another aspect, a computer method for controlling the access of users to advanced medical diagnostic imaging applications performing the action of retrieving based on a received login credential the access policy to advanced medical diagnostic imaging applications for the user; receiving a request for advanced medical diagnostic imaging applications from the user; configuring the advanced medical diagnostic imaging applications based on the retrieved access policy for the user; and presenting the configured advanced medical diagnostic imaging applications to the user.

In one aspect, a system to control the access of users to advanced medical diagnostic imaging employing a processor; a storage device coupled to the processor for storing access policy to advanced medical diagnostic imaging applications for each user; software means operative on the processor for performing the function of retrieving based on a received login credential the access policy for the user from the storage device; receiving request for advanced medical diagnostic imaging applications from the user; configuring the advanced medical diagnostic imaging applications based on the retrieved access policy for the user; and presenting the configured advanced medical diagnostic imaging applications to the user.

In yet a further aspect, a user interface for adding new users and modifying access policy of users of the advanced medical diagnostic imaging applications, adding to the storage device a grouping of user types that have the same permission level.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram illustrating a system-level overview of an embodiment for acquiring medical images;

FIG. 2 is a diagram illustrating a system-level overview of another embodiment for acquiring medical images;

FIG. 3 is a block diagram of hardware and operating environment in which different embodiments can be practiced.

FIG. 4 is a flowchart of a method performed by a client according to an embodiment;

FIG. 5 is a diagram of an access policy data structure for use in an implementation;

FIG. 6 is a diagram of a users data structure for use in an implementation;

FIG. 7 is a diagram of privileges data structure for use in an implementation;

FIG. 8 is a flowchart of a method performed by a client according to an embodiment for modifying an imaging application in accordance to an access policy.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

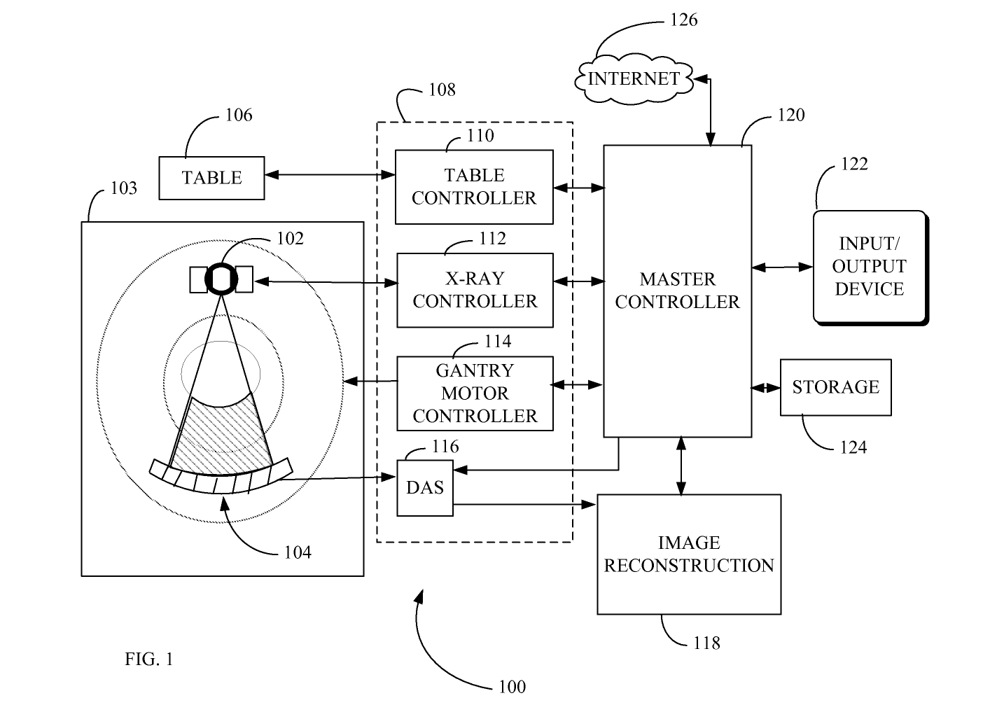

FIG. 1 is a block diagram of an overview of a system for acquiring medical images. CT imaging system 100 solves the need in the art for managing advanced medical diagnostic imaging applications executing on a network or a computer. CT imaging system 100 includes a gantry 103, table 106, controllers 108, master controller, and image reconstruction device 118. It should be noted that other data acquisition systems are envisioned including a magnetic resonance (MRI) imaging system, a positron emission tomography (PET) system, a single photon emission computed tomography (SPECT) system, an ultrasound system, or an X-ray system. The data acquisition system obtains data including, but not limited to image data, functional image data, and temporal image data. Further examples of data include voxel data including volume information for a three dimensional region of interest (ROI), pixel data including area information for a two dimensional region of interest, and spatio-temporal data. Spatio-temporal data includes area or volume information over a selected, predetermined time period.

CT imaging system 100 includes a gantry 103 having an x-ray source 102, a radiation detector array 104, a patient support structure and a patient cavity, wherein the x-ray source 102 and the radiation detector array 104 are diametrically disposed so as to be separated by the patient cavity. In an exemplary embodiment, a patient (not shown) is disposed upon the patient support structure, which is then disposed within the patient cavity. The x-ray source 102 projects an x-ray beam toward the radiation detector array 104 so as to pass through the patient. In an exemplary embodiment, the x-ray beam is collimated by a collimate (not shown) so as to lie within an X-Y plane of a Cartesian coordinate system referred known to those in the art as the imaging plane. After becoming attenuated by the patient passing through, the attenuated x-ray beam is received by the radiation detector array 104. In preferred embodiment, the radiation detector array 104 includes a plurality of detector elements wherein each of said detector elements receives an attenuated x-ray beam and produces an electrical signal responsive to the intensity of the attenuated x-ray beam.

In addition, the x-ray source 102 and the radiation detector array 104 can rotate relative to the gantry 103 and the patient support structure, so as to allow the x-ray source 102 and the radiation detector array 104 to rotate around the patient support structure when the patient support structure is disposed within the patient cavity. X-ray projection data is obtained by rotating the x-ray source 102 and the radiation detector array 104 around the patient during a scan. The x-ray source 102 and the radiation detector array 104 communicate with a control mechanism 108 associated with the CT imaging system 100. The control mechanism 108 controls the rotation and operation of the x-ray source 102 and the radiation detector array 104.

The table controller 110, X-Ray controller, gantry motor controller, DAS 116, image reconstruction 118, and master controller 120 have the same hardware and capabilities that is only limited by the programming in each respective device. For the purpose of the description, all controllers are presumed to have the same hardware so a discussion to one applies to all. The master controller 120 provides computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

The master controller 120 includes a processor, commercially available from Intel, Motorola, Cyrix and others. Master controller 120 also includes random-access memory (RAM), read-only memory (ROM), and one or more mass storage devices 124, and a system bus that operatively couples various system components to the processing unit of master controller 120. The memory and mass storage devices are types of computer-accessible media. Mass storage devices are more specifically types of nonvolatile computer-accessible media and can include one or more hard disk drives, floppy disk drives, optical disk drives, and tape cartridge drives. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory. The processor in the master controller executes computer programs stored on the computer-accessible media.

Master controller 120 can be communicatively connected to the Internet 126 via a communication device. Internet 126 connectivity is well known within the art. In one embodiment, a communication device is a modem that responds to communication drivers to connect to the Internet via what is known in the art as a “dial-up connection.” In another embodiment, a communication device is an Ethernet® or similar hardware network card connected to a local-area network (LAN) that itself is connected to the Internet via what is known in the art as a “direct connection” (e.g., T1 line, etc.).

A user enters commands and information into the master controller 120 through input device 122 such as a keyboard or a pointing device. The keyboard permits entry of textual information into master controller 120, as known within the art, and embodiments are not limited to any particular type of keyboard. Pointing device permits the control of the screen pointer provided by a graphical user interface (GUI) of operating systems such as versions of Microsoft Windows®. Embodiments are not limited to any particular pointing device. Such pointing devices include mice, touch pads, trackballs, remote controls and point sticks. Other input devices (not shown) can include a microphone, joystick, game pad, satellite dish, scanner, or the like. For the purpose of this description, a keyboard and a pointing device are referred to as a user interface (UI) that allows the user to interact with the automated calcium detection system, algorithm, or structure. The output device is a display device. Display device is connected to the system bus. Display device permits the display of information, including computer, video and other information, for viewing by a user of the computer. Embodiments are not limited to any particular display device. Such display devices include cathode ray tube (CRT) displays (monitors), as well as flat panel displays such as liquid crystal displays (LCD's). In addition to a monitor, computers typically include other peripheral input/output devices such as printers (not shown). The controllers also include an operating system (not shown) that is stored on the computer-accessible media RAM, ROM, and mass storage device 124, and is and executed by the processor in the controller. Examples of operating systems include Microsoft Windows®, Apple MacOS®, Linux®, UNIX®. Examples are not limited to any particular operating system, however, and the construction and use of such operating systems are well known within the art.

Master controller 120 can be operated using at least one operating system to provide a graphical user interface (GUI) including a user-controllable pointer. Master controller can have at least one web browser application program executing within at least one operating system, to permit users of the controller to access intranet or Internet world-wide-web pages as addressed by Universal Resource Locator (URL) addresses. Examples of browser application programs include Netscape Navigator® and Microsoft Internet Explorer

In an exemplary embodiment, the control mechanism 108 includes an x-ray controller 112 communicating with an x-ray source 102, a gantry motor controller 114, and a data acquisition system (DAS) 116 communicating with a radiation detector array 104. The x-ray controller 112 provides power and timing signals to the x-ray source 102, the gantry motor controller 114 controls the rotational speed and angular position of the x-ray source 102, and the radiation detector array 104 and the DAS 116 receive the electrical signal data produced by detector elements 104 and convert this data into digital signals for subsequent processing. In an exemplary embodiment, the CT imaging system 100 also includes an image reconstruction device 118, a data storage device 124 and a master controller 120, wherein the processing device 120 communicates with the image reconstruction device 118, the gantry motor controller 114, the x-ray controller 112, the data storage device 124, an input and an output device 122. The CT imaging system 100 can also include a table controller 110 in communication with the master controller 120 and the patient support structure, so as to control the position of the patient support structure relative to the patient cavity.

In accordance with the preferred embodiment, the patient is disposed on the patient support structure, which is then positioned by an operator via the master controller 120 so as to be disposed within the patient cavity. The gantry motor controller 114 is operated via master controller 120 so as to cause the x-ray source 4 and the radiation detector array 6 to rotate relative to the patient. The x-ray controller 112 is operated via the master controller 120 so as to cause the x-ray source 102 to emit and project a collimated x-ray beam toward the radiation detector array 104 and hence toward the patient. The x-ray beam passes through the patient so as to create an attenuated x-ray beam, which is received by the radiation detector array 104.

The detector elements 104 receive the attenuated x-ray beam, produce electrical signal data responsive to the intensity of the attenuated x-ray beam and communicate this electrical signal data to the DAS 116. The DAS 116 then converts this electrical signal data to digital signals and communicates both the digital signals and the electrical signal data to the image reconstruction device 118, which performs high-speed image reconstruction. This information is then communicated to the master controller 120, which stores the image in the data storage device 124 and displays the digital signal as an image via output device 122. The information communicated to the master controller 120 is referred to as ROI image data. In accordance with an exemplary embodiment, the output device 122 includes a display screen having a plurality of discrete pixel elements.

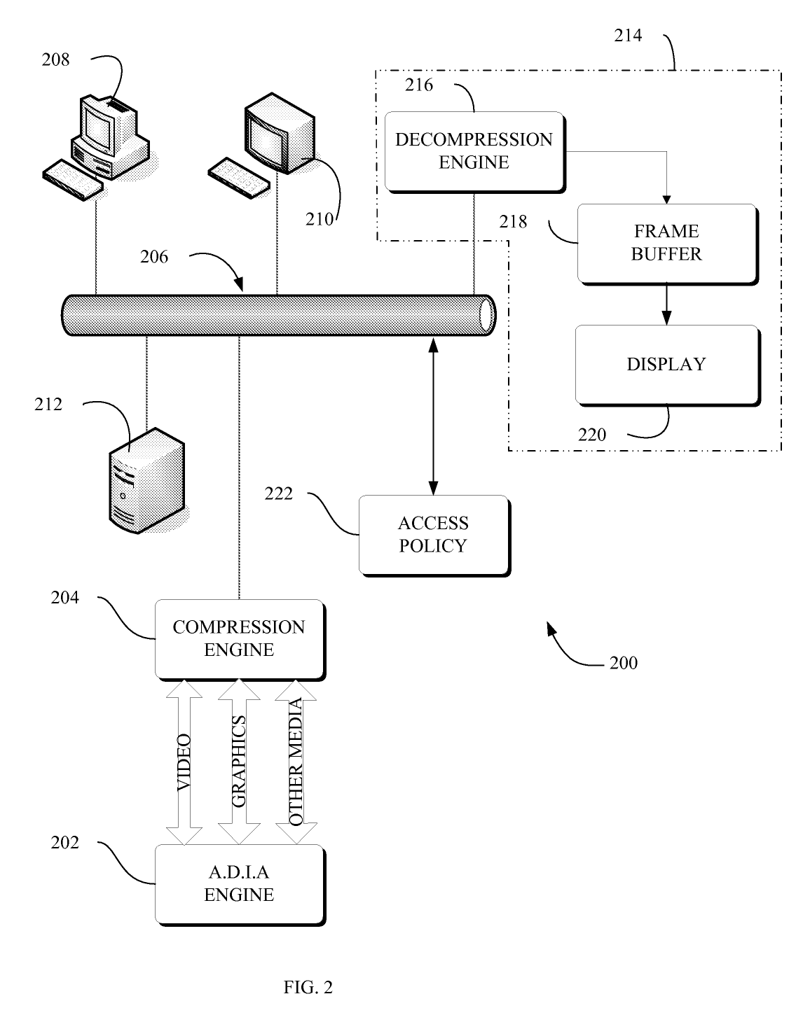

FIG. 2 depicts a network arrangement 200 for acquiring post processing advanced diagnostic imaging applications (ADIA). These ADIA refer to post processing software meant to perform advanced processing and visualization of medical image data. A user through terminals 208, 210, or 214 uploads or downloads software from ADIA component 202. The software from ADIA component 202 may be stored in storage server 212 for use at a later time by computer system 214 or any other computer in communication with ADIA component 202. Further, the software in server 212 can be stored in compressed or decompressed format and will depend on the available resources at system 200. For example, to preserve the bandwidth of the network 206 for other users or applications it would be more advantageous to store the software in a compressed state. However, in a direct connection between the computer system 214 and the server 212 uncompressed software is preferred since it would negate the inherent delays introduced by the decompression procedure 216 at display 220. In the preferred embodiment, a user at terminal 214 can access ADIA component 202 through network 206. In other embodiments, ADIA component 202 can reside on an intranet, an extranet, a local area network (“LAN”), a wide area network (“WAN”), or any other type of network or stand-alone computer. If the ADIA component 202 resides on a network, then the computer or terminal at 214 is any machine or device capable of connecting to that network. If the ADIA component 202 can be accessed by the Internet, then the computer or terminal at 214 is any machine or device capable of connecting to the Internet. If the computer system at 214 is a stand-alone computer, then the ADIA component is the same device as the computer at 214. The user can be linked to the ADIA component 202 by fiber optic cable, wireless system, by a gateway, by a network, or a combination of these linking devices.

ADIA component 202 produces stream of data consisting of one or more software that when used at computer 214 permits the user to interact with medical data such as medical images produced by computer tomography (CT) 100 shown in FIG. 1. The stream of data can be referred to as input data, as an input data stream, as mixed media data, and as mixed media data stream without departing from the original concept of having data be one or more software application capable of manipulating image, video, graphics, text, animation, or any other data or information useable in the field of medicine. ADIA component 202 can be used in higher resolution medical imaging, in computed tomography (CT) and magnetic resonance imaging (MRI), in 3D visualization that permits rotation and scaling, or for any other purpose that aides in the understating of the physical world.

Compression component 204 is one or more compression scheme that could be used for compressing the stream data produced by the ADIA component 202. This compression can be applied to regions of the data stream or to the whole stream. Optional frame buffer 218 holds the data stream until it can be displayed. Frame buffer 218, constituted of a writable semiconductor memory (SDRAM (Synchronous Dynamic Random Access Memory), for example), a DRAM (Dynamic Random Access Memory), a Rambus DRAM or the like and writes and stores the mixed media data per screen (frame) transferred via a data bus from decompression component 216.

Access policy component 222 is used to customize the applications (software) from ADIA component 202 to the capabilities, privileges of the users at computer 214. Customization of advanced diagnostic imaging applications prevents misdiagnosis due to lack of training or from unauthorized modification by unsuitable users. Customization of such applications and features include vessel analysis applications with vessel centerline tracking, stenosis analysis, and stent planning features, cardiac applications with cardiac function and perfusion features, oncology applications with features to identify and quantify cancerous lesions. Example of specific control features that may need to be managed based on a user's profile are saving, deleting, and editing specific applications. The purpose of this customization is to provide a vehicle for managing access to these applications and features in a distributed environment, such that only trained and authorized users can access the appropriate features and applications. The identity of users at computer 214 can be ascertained from the password of the user, the login identity of the user, a token transmitted to identify the user, RFID tag that identifies the system or the user, or any other form of identification that can convey the identity of the user.

An access policy (222) for remotely accessing a set of advanced medical diagnostic imaging applications (ADIA) should insure that applications and users have some of the following capabilities: (1) application users may log into the system to access advanced medical imaging applications, the login credentials will be stored on the system, and will be verified at login time; (2) each application user accessing the system has associated with login credentials, specific permissions regarding the ability to access each application in the system; (3) each application on the system may define particular configurable features and associated modes of that feature, which should be launched into a different mode when a user with specified feature level permissions launches the application; (4) each application user accessing the system has associated with his login credentials, specific permissions regarding the ability to access specific features of each application—for example, some users may have access to the advanced 3D tools in a particular analysis application due to their training, while other users who are not trained, will not have access to these features.

Additionally, the access policy 222 should utilize an administrator user who has the ability to perform any of the following functions: (a) define and modify application and feature level permissions for each application user; (b) define and manage groups of user types with the same permission levels for each application and application features, so new users can be added to a user type group to conveniently define their permissions; (c) add new application users to the system, or delete existing users. New users may have their application and feature permissions defined either directly, or by being associated with a specific user type group.

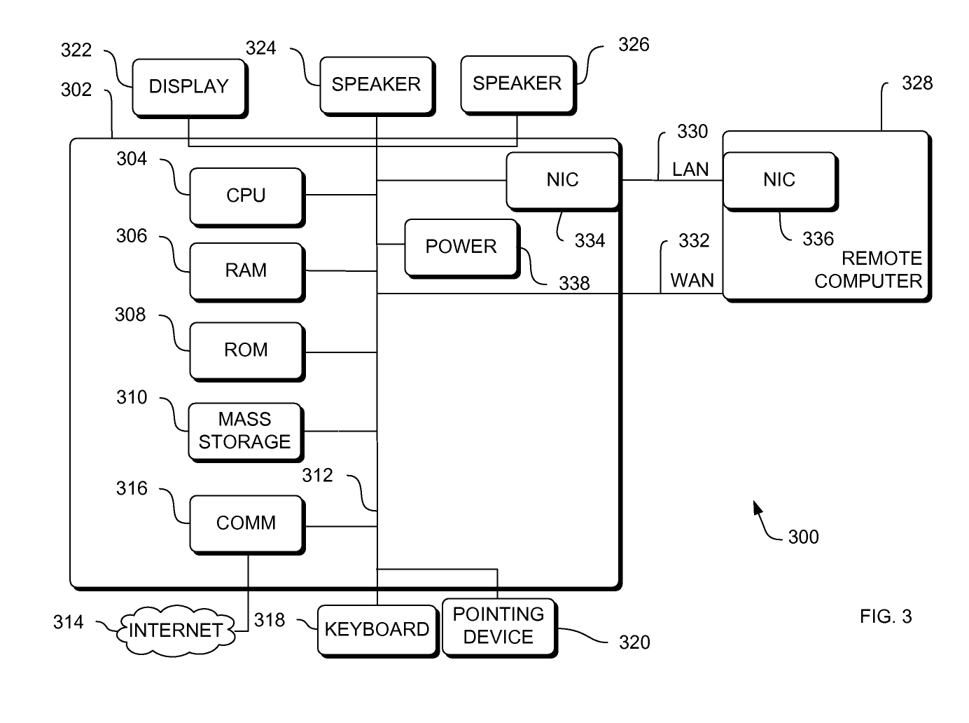

FIG. 3 is a block diagram of a hardware and operating environment 300 in which different embodiments can be practiced. The description of FIG. 3 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 302 includes a processor 304, commercially available from Intel, Motorola, Cyrix and others. Computer 302 also includes random-access memory (RAM) 306, read-only memory (ROM) 308, and one or more mass storage devices 310, and a system bus 312, that operatively couples various system components to the processing unit 304. The memory 306, 308, and mass storage devices, 310, are types of computer-accessible media. Mass storage devices 310 are more specifically types of nonvolatile computer-accessible media and can include one or more hard disk drives, floppy disk drives, optical disk drives, and tape cartridge drives. The processor 304 executes computer programs stored on the computer-accessible media.

Computer 302 can be communicatively connected to the Internet 314 via a communication device 316. Internet 314 connectivity is well known within the art. In one embodiment, a communication device 316 is a modem that responds to communication drivers to connect to the Internet via what is known in the art as a “dial-up connection.” In another embodiment, a communication device 316 is an Ethernet® or similar hardware network card connected to a local-area network (LAN) that itself is connected to the Internet via what is known in the art as a “direct connection” (e.g., T1 line, etc.).

A user enters commands and information into the computer 302 through input devices such as a keyboard 318 or a pointing device 320. The keyboard 318 permits entry of textual information into computer 302, as known within the art, and embodiments are not limited to any particular type of keyboard. Pointing device 320 permits the control of the screen pointer provided by a graphical user interface (GUI) of operating systems such as versions of Microsoft Windows®. Embodiments are not limited to any particular pointing device 320. Such pointing devices include mice, touch pads, trackballs, remote controls and point sticks. Other input devices (not shown) can include a microphone, joystick, game pad, satellite dish, scanner, or the like.

In some embodiments, computer 302 is operatively coupled to a display device 322. Display device 322 is connected to the system bus 312. Display device 322 permits the display of information, including computer, video and other information, for viewing by a user of the computer. Embodiments are not limited to any particular display device 322. Such display devices include cathode ray tube (CRT) displays (monitors), as well as flat panel displays such as liquid crystal displays (LCD's). In addition to a monitor, computers typically include other peripheral input/output devices such as printers (not shown). Speakers 324 and 326 provide audio output of signals. Speakers 324 and 326 are also connected to the system bus 312.

Computer 302 also includes an operating system (not shown) that is stored on the computer-accessible media RAM 306, ROM 308, and mass storage device 310, and is and executed by the processor 304. Examples of operating systems include Microsoft Windows®, Apple MacOS®, Linux®, UNIX®. Examples are not limited to any particular operating system, however, and the construction and use of such operating systems are well known within the art.

Embodiments of computer 302 are not limited to any type of computer 302. In varying embodiments, computer 302 comprises a PC-compatible computer, a MacOS®-compatible computer, a Linux®-compatible computer, or a UNIX®-compatible computer. The construction and operation of such computers are well known within the art.

Computer 302 can be operated using at least one operating system to provide a graphical user interface (GUI) including a user-controllable pointer. Computer 302 can have at least one web browser application program executing within at least one operating system, to permit users of computer 302 to access an intranet, extranet or Internet world-wide-web pages as addressed by Universal Resource Locator (URL) addresses. Examples of browser application programs include Netscape Navigator® and Microsoft Internet Explorer®.

The computer 302 can operate in a networked environment using logical connections to one or more remote computers, such as remote computer 328. These logical connections are achieved by a communication device coupled to, or a part of, the computer 302. Embodiments are not limited to a particular type of communications device. The remote computer 328 can be another computer, a server, a router, a network PC, a client, a peer device or other common network node. The logical connections depicted in FIG. 3 include a local-area network (LAN) 330 and a wide-area network (WAN) 332. Such networking environments are commonplace in offices, enterprise-wide computer networks, intranets, extranets and the Internet.

When used in a LAN-networking environment, the computer 302 and remote computer 328 are connected to the local network 330 through network interfaces or adapters 334, which is one type of communications device 316. Remote computer 328 also includes a network device 336. When used in a conventional WAN-networking environment, the computer 302 and remote computer 328 communicate with a WAN 332 through modems (not shown). The modem, which can be internal or external, is connected to the system bus 312. In a networked environment, program modules depicted relative to the computer 302, or portions thereof, can be stored in the remote computer 328.

Computer 302 also includes power supply 338. Each power supply can be a battery.

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 400 and 800 are performed by a program executing on, or performed by firmware or hardware that is a part of, a computer, such as computer 302 in FIG. 3.

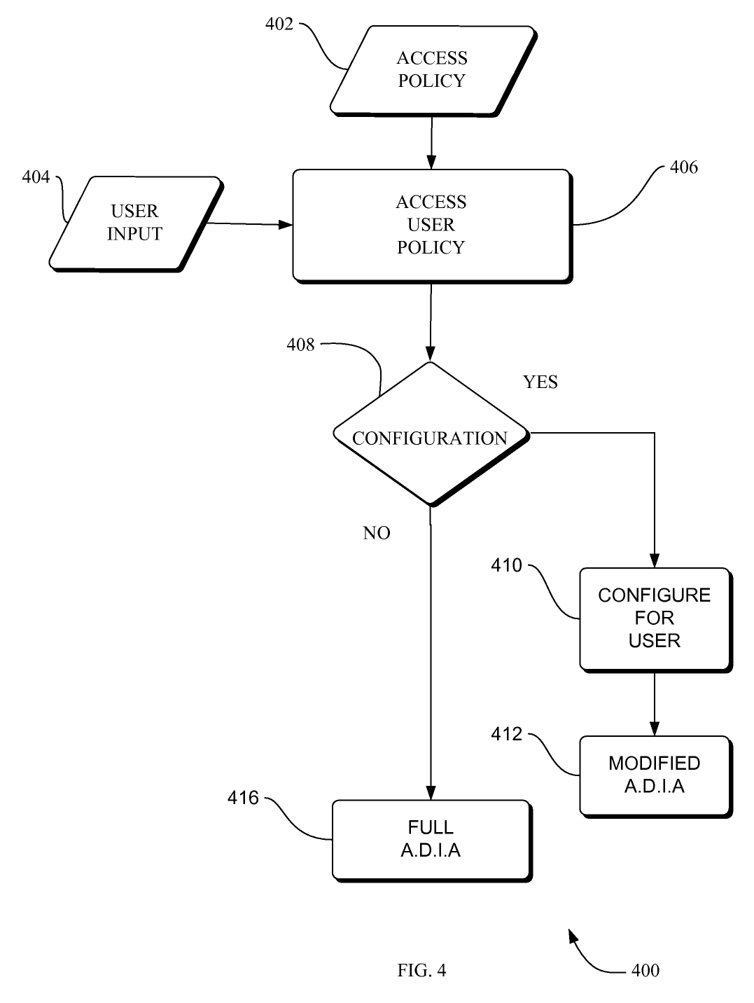

FIG. 4 is a flowchart of a method 400 performed by a client according to an embodiment. Method 400 solves the need in the art for managing advanced medical diagnostic imaging applications executing on a network or a computer. Method 400 provides a framework for a hospital or other healthcare provider that use advanced medical imaging applications (ADIA), to easily manage access to these application so that: Application licenses are not wasted, Key users have access to the applications, Untrained users cannot use applications/features they are not trained to use, Unauthorized users do not have access to applications/features they are not meant to use.

Method 400 includes access policy 402, user input 404, access user policy 406, and configuration 408 that provides the user with full advanced diagnostic imaging applications (ADIA) 416 or modified advanced diagnostic imaging applications (ADIA) 412 that has been configured for the user 410.

Method 400 begins with access policy 402. The access policy 402 is operational logic that reserves access to applications (ADIA) for the specific users who derive the maximum benefit. The access policy is one of no access to the advanced medical diagnostic imaging applications, limited access to the advanced medical diagnostic imaging applications, or unfettered access to the advanced medical diagnostic imaging applications. The access policy 402 is forwarded to the access user policy 406 for processing in accordance to user input 404.

Action 404, acquires a user input. The user input 404 can be one or more password, token, data signal, login identification. The user input 404 may further include receiving a user password via the password input device (122. 318, 320), generating a password encryption key based on the user password, encrypting a known value with the password encryption key to produce an encrypted output, and storing the encrypted known value in the memory. Alternatively or in addition the user input 404 can be a token that can be carried by the user to enhance the security to the imaging system 100. Examples of such a token include smart cards and USB key fobs. The user input 404 is forwarded to access user policy 406 for processing in accordance to access policy 402.

In access user policy 406 the policy for the user is determined. The access user policy 406 combines the received information to answer if the user is one or more key user, authorized user, trained user, untrained user, unauthorized user, invited user. The category of the user will determine the applications and the features that are associated with the password of the user.

The access user policy 406 maintains a directory of the advanced diagnostic imaging applications and the different possible configuration features. For example, applications such as 2D viewer and 3D review can have the following configurable features:

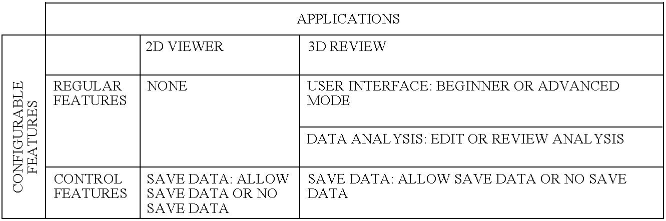

The access user policy 406 will additionally maintain a directory of how these features will be presented to the user. In the case of basic diagnosis user a possible configuration can be access to 2D Viewer: all features; access to 3D Review: all features and access to advanced applications only beginner's mode, edit analysis mode, save data mode. However, for an advanced diagnosis user access to 2D Viewer: all features; access to 3D Review: all features access to advanced applications: all features. In contrast an invited user such as a referring physician access to 2D Viewer with no save features, no access to 3D Review, access to advanced applications at only beginner's mode, only review mode, and no save features. Once the access user policy has been tailored to the user input 404 control passes to action 408 for further processing.

In action 408, a decision is made as to whether or not the ADIA received by the user will be configured. When the determination is “YES” then the features are configured for the user (410, 412); when the determination is “NO” the advanced diagnostic imaging applications are forwarded to the user 416 without any discernable modification to the functionality of the software applications.

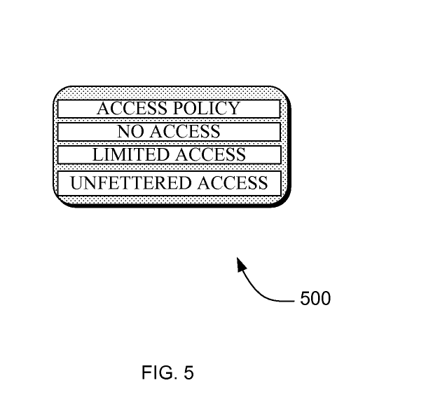

As shown in FIG. 5, the access policy 402 can be expressed as a data structure 500 comprising no access policy, limited access policy, unfettered access policy. These access policies have pointers to a local memory address such as memory 306 in FIG. 3.

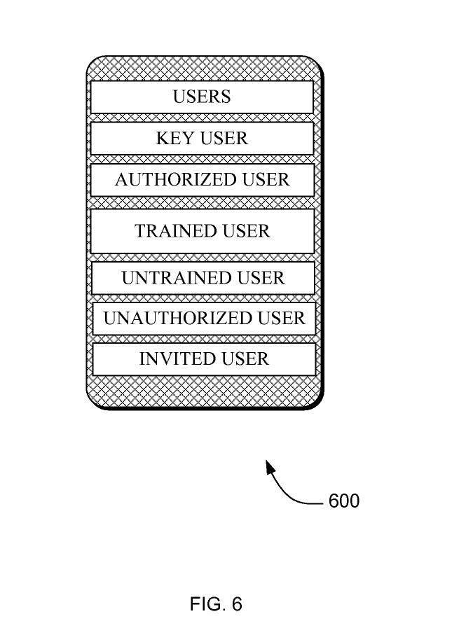

As shown in FIG. 6, the users can be expressed as a data structure 600 comprising key user, authorized user, trained user, and untrained user, authorized user, or invited user. These user categories can have pointers to a local memory address such as memory 306 in FIG. 3. A user can be assigned a category for each type of advanced diagnostic imaging applications.

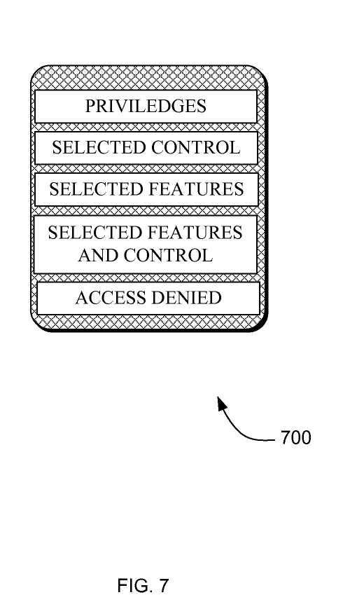

As shown in FIG. 7, the privileges of the users can be expressed as a data structure 700 comprising selected control, selected features, selected features and control, and access denied. These user privileges can have pointers to a local memory address such as memory 306 in FIG. 3.

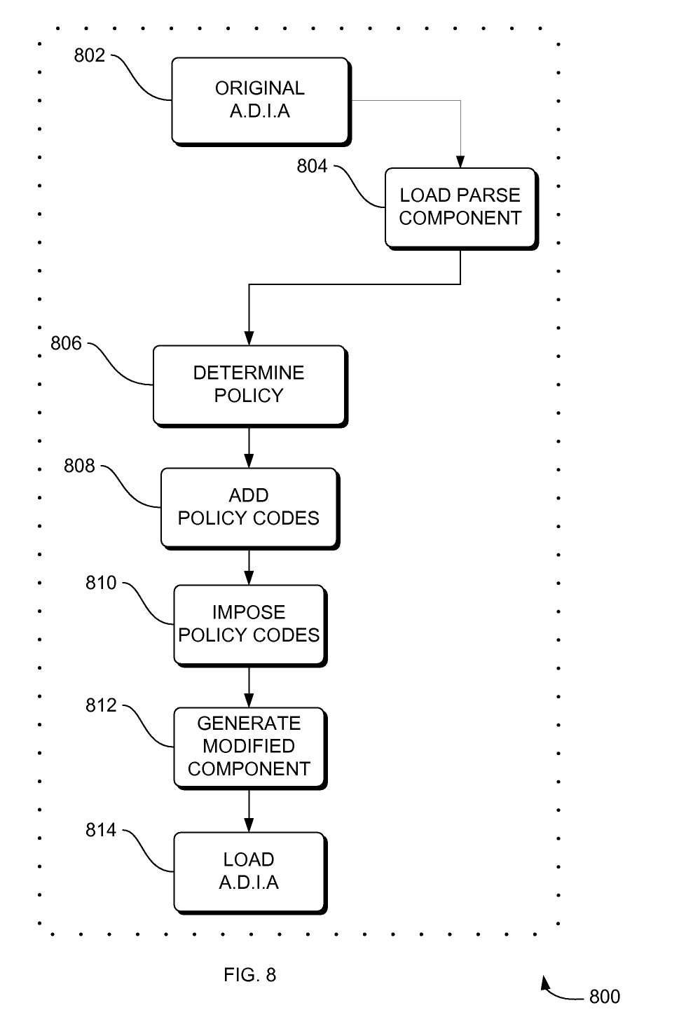

FIG. 8 is a flowchart of a method 800 performed by a client according to an embodiment for configuring software for a specified user. Method 800 solves the need in the art for managing advanced medical diagnostic imaging applications executing on a network or a computer. Method 800 provides a framework for a hospital or other healthcare provider that use advanced medical imaging applications (ADIA), to easily manage access to these application so that: Application licenses are not wasted, Key users have access to the applications, Untrained users cannot use applications/features they are not trained to use, Unauthorized users do not have access to applications/features they are not meant to use.

Method 800 includes loading parse components 804 from an original ADIA 802, determining user policy 806, and adding policy codes 808 to the ADIA, imposing policy codes 810, and generating modified component 812 so as to provide the user with customized advanced diagnostic imaging applications (ADIA).

Method 800 begins with action 802 where the control and data flow for loading an original software component 802 and creating a modified software component 814 are illustrated. A computer system or workstation (214 at FIG. 2) to which the original software component is directed for execution issues a command to load the software component. Instead, the original software component is loaded and parsed as indicated in a block 804.

Action 804, determines abstractions or object types that are supported by the software component, as well as the operations on these abstractions. Additionally, the load parse component 804 determines the configuration features for the software component that may be required during execution of the component.

Action 806 receives or acquires the access user policy for the user requesting the advanced diagnostic imaging applications.

In action 808 the policy code is added to the requested software. Based upon the access user policy 806 data, action 808 adds policy code to the software component.

In action 810 imposes policy code on the original component that modify the operations of the ADIA software.

In action 812, modified ADIA software is generated based on the imposed policy codes of action 810. The modified software can now be linked into the component system and loaded for execution, as indicated inaction 804.

In action 814, the ADIA software is loaded at the requesting computer system. The ADIA executes on the component system in the same manner it would have prior to modification by action 812 with only the features suited for the user activated.

In some embodiments, methods 400 and 800 are implemented as a computer data signal embodied in a carrier wave, that represents a sequence of instructions which, when executed by a processor, such as processor 304 in FIG. 3, cause the processor to perform the respective method. In other embodiments, methods 800 and 400 are implemented as a computer-accessible medium having executable instructions capable of directing a processor, such as processor 304 in FIG. 3, to perform the respective method. In varying embodiments, the medium is a magnetic medium, an electronic medium, or an optical medium.

Referring to FIG. 2, a particular implementation 200 is described in conjunction with the system overview in FIG. 1 and the methods described in conjunction with FIGS. 4 and 8. The figures use the Unified Modeling Language (UML), which is the industry-standard language to specify, visualize, construct, and document the object-oriented artifacts of software systems. In the figures, a hollow arrow between classes is used to indicate that a child class below a parent class inherits attributes and methods from the parent class. In addition, a solid-filled diamond is used to indicate that an object of the class that is depicted above an object of another class is composed of the lower depicted object. Composition defines the attributes of an instance of a class as containing an instance of one or more existing instances of other classes in which the composing object does not inherit from the object(s) it is composed of.

Apparatus 200 solves the need in the art for managing advanced medical diagnostic imaging applications executing on a network or a computer.

Apparatus 200 component access policy 222 can be embodied as computer hardware circuitry or as a computer-readable program, or a combination of both. In another embodiment, system 200 is implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 302 in FIG. 3, or on at least as many computers as there are components.

### CONCLUSION

A method and system for managing levels of access is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A computer-accessible medium having executable instructions for controlling the access of users to advanced medical diagnostic imaging applications, the executable instructions capable of directing a processor to perform:
receiving login credential from a user;
retrieving based on the received login credential of the user the access policy to advanced medical diagnostic imaging applications for the user;
configuring desired advanced medical diagnostic imaging applications based on the retrieved access policy for the user; and
presenting the configured advanced medical diagnostic imaging applications to the user.

2. The computer-accessible medium of claim 1, wherein the login credential from the user is one or more password, token, data signal, login identification.

3. The computer-accessible medium of claim 1, wherein the access policy is one of no access to the advanced medical diagnostic imaging applications, limited access to the advanced medical diagnostic imaging applications, or unfettered access to the advanced medical diagnostic imaging applications.

4. The computer-accessible medium of claim 1, wherein users are one or more key user, authorized user, trained user, untrained user, unauthorized user, invited user.

5. The computer-accessible medium of claim 1, wherein configuring desired advanced medical diagnostic imaging applications is one of denying access to the user, providing access only to some of the features of the desired advanced medical diagnostic imaging applications, denying access to control features of the desired advanced medical diagnostic imaging applications, denying access to some features and to control features of the desired advanced medical diagnostic imaging applications.

6. The computer-accessible medium of claim 5, wherein a control feature is at least editing feature, saving feature, deleting feature, opening feature.

7. A computer method for controlling the access of users to advanced medical diagnostic imaging applications comprising:
retrieving based on a received login credential the access policy to advanced medical diagnostic imaging applications for the user;
receiving a request for advanced medical diagnostic imaging applications from the user;
configuring the advanced medical diagnostic imaging applications based on the retrieved access policy for the user; and
presenting the configured advanced medical diagnostic imaging applications to the user.

8. The computer method of claim 7, wherein the login credential from the user is one or more password, token, data signal, login identification.

9. The computer method of claim 7, wherein the access policy is one of no access to the advanced medical diagnostic imaging applications, limited access to the advanced medical diagnostic imaging applications, or unfettered access to the advanced medical diagnostic imaging applications.

10. The computer method of claim 7, wherein users are one or more key user, authorized user, trained user, untrained user, unauthorized user, invited user.

11. The computer method of claim 7, wherein configuring desired advanced medical diagnostic imaging applications is one of denying access to the user, providing access only to some of the features of the desired advanced medical diagnostic imaging applications, denying access to control features of the desired advanced medical diagnostic imaging applications, denying access to some features and to control features of the desired advanced medical diagnostic imaging applications.

12. The computer method of claim 11, wherein a control feature is at least editing feature, saving feature, deleting feature, opening feature.

13. A system to control the access of users to advanced medical diagnostic imaging applications comprising:
a processor;
a storage device coupled to the processor for storing access policy to advanced medical diagnostic imaging applications for each user;
software means operative on the processor for:
retrieving based on a received login credential the access policy for the user from the storage device;
receiving request for advanced medical diagnostic imaging applications from the user;
configuring the advanced medical diagnostic imaging applications based on the retrieved access policy for the user; and
presenting the configured advanced medical diagnostic imaging applications to the user.

14. The system of claim 13, wherein the login credential from the user is one or more password, token, data signal, login identification.

15. The system of claim 13, wherein the access policy is one of no access to the advanced medical diagnostic imaging applications, limited access to the advanced medical diagnostic imaging applications, or unfettered access to the advanced medical diagnostic imaging applications.

16. The system of claim 13, wherein users are one or more key user, authorized user, trained user, untrained user, unauthorized user, invited user.

17. The system of claim 13, wherein configuring desired advanced medical diagnostic imaging applications is one of denying access to the user, providing access only to some of the features of the desired advanced medical diagnostic imaging applications, denying access to control features of the desired advanced medical diagnostic imaging applications, denying access to some features and to control features of the desired advanced medical diagnostic imaging applications.

18. The system of claim 17, wherein a control feature is at least editing feature, saving feature, deleting feature, opening feature.

19. The system of claim 13, the system further comprising:
a user interface for adding new users and modifying access policy of users of the advanced medical diagnostic imaging applications.

20. The system of claim 17, the system further comprising:
adding to the storage device a grouping of user types that have the same permission level.
